(19) United States
(12) Patent Application Publication
(10) Pub. No.: US 2008/0058060 A1
(43) Pub. Date: Mar. 6, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/589,158

(22) Filed: Oct. 30, 2006

Related U.S. Application Data
(60) Provisional application No. 60/842,022, filed on Sep. 5, 2006.

(51) Int. Cl. A63F 13/00

(52) U.S. Cl. 463/20

(57) ABSTRACT

The symbols are rearranged. A partial symbol matrix among the rearranged symbols is set in a rotatable area. The partial symbol matrix is rotated in accordance with an operation signal inputted from an exterior and is thus rearranged. A payout is awarded which is determined by a combination of the symbols rearranged on a payline.

### CROSS REFERENCE TO RELATED APPLICATION

This application claims the benefit of U.S. Provisional Application No. 60/842,022, filed on Sep. 5, 2006.

### BACKGROUND OF THE INVENTION

1. Field of the Invention

The invention relates to a slot machine and a playing method thereof.

2. Description of Related Art

In a conventional slot machine, when a player inserts a game medium such as coin or bill into an insertion slot of the slot machine and pushes a spin button, plural symbols are scroll-displayed in a display mounted on a front of a cabinet and the symbols are then stopped automatically.

In such slot machine, as disclosed in U.S. Pat. No. 6,604,999 B2 or U.S. Patent No. 2002065124A1, for example, when the symbols stopped on a payline constitute a predetermined combination, predetermined number of game media is paid out. In addition, when a certain symbol referred to as scatter symbol is displayed on the display, predetermined number of game media is paid out in accordance with the number of scatter symbols displayed, irrespective of the payline. In other words, in the conventional slot machine, the payout is made in combination with the two methods.

The invention provides a slot machine having an entertainment characteristic, which is not provided to the prior art, and a playing method thereof.

### SUMMARY OF THE INVENTION

The invention provides a slot machine comprising structures below and having a display and a game controller. The display has a payline and arranges plural symbols in a matrix pattern. The game controller rearranges the symbols, sets, among the rearranged symbols, a partial symbol matrix in a rotatable area, and rotates the partial symbol matrix in accordance with an operation signal inputted from an exterior to rearrange it. The game controller awards a payout determined by a combination of the symbols rearranged on the payline.

In the slot machine of the invention, a partial symbol matrix among the rearranged symbols is set in a rotatable area. The partial symbol matrix is rotated in accordance with an operation signal inputted from the exterior and is thus rearranged. Then, a payout is awarded on the basis of a combination of the symbols rearranged on the payline.

The invention provides a slot machine comprising structures below and having a display and a game controller. The display has a payline and arranges plural symbols in a matrix pattern. The game controller rearranges the symbols, selects, among the rearranged symbols, a partial symbol matrix, based on an operation signal inputted from an exterior, when it is made a predetermined unit game-number, and sets the symbol matrix in a rotatable area. The game controller rotates the partial symbol matrix in accordance with the operation signal to rearrange it. The game controller awards a payout determined by a combination of the symbols rearranged on the payline.

In the slot machine of the invention, when it is made a predetermined unit game-number, a partial symbol matrix is selected, on the basis of an operation signal inputted from the exterior, among the rearranged symbols and the symbol matrix is set in a rotatable area. The partial symbol matrix is rotated in accordance with an operation signal inputted from the exterior and is thus rearranged. Then, a payout is awarded on the basis of a combination of the symbols rearranged on the payline.

The invention provides a slot machine comprising structures below and having a display, a touch panel and a game controller. The display has a payline and arranges plural symbols in a matrix pattern. The touch panel is provided to a front surface of the display and outputs an operation signal through an exterior input. The game controller rearranges the symbols, selects, among the rearranged symbols, a partial symbol matrix, based on the operation signal, and sets the symbol matrix in a rotatable area. The game controller rotates the partial symbol matrix in accordance with the operation signal to rearrange it. The game controller awards a payout determined by a combination of the symbols rearranged on the payline.

In the slot machine of the invention, a partial symbol matrix is selected among the rearranged symbols on the basis of an operation signal inputted from a touch panel, and the symbol matrix is set in a rotatable area. The partial symbol matrix is rotated in accordance with the operation signal inputted from the touch panel and is thus rearranged. Then, a payout is awarded on the basis of a combination of the symbols rearranged on the payline.

The invention provides a slot machine comprising structures below and having a display, a touch panel and a game controller. The display has a payline and arranges plural symbols in a matrix pattern. The touch panel is provided to a front surface of the display and outputs an operation signal through an exterior input. The game controller rearranges the symbols, selects, among the rearranged symbols, a partial symbol matrix, based on the operation signal, when it is made a predetermined unit game-number, and sets the symbol matrix in a rotatable area. The game controller rotates the partial symbol matrix in accordance with the operation signal to rearrange it. The game controller awards a payout determined by a combination of the symbols rearranged on the payline.

In the slot machine of the invention, when it is made a predetermined unit game-number, a partial symbol matrix is selected among the rearranged symbols on the basis of an operation signal inputted from a touch panel and the symbol matrix is set in a rotatable area. The partial symbol matrix is rotated in accordance with the operation signal inputted from the touch panel and is thus rearranged. Then, a payout is awarded on the basis of a combination of the symbols rearranged on the payline.

The invention provides a playing method of a slot machine having structures below. Symbols are rearranged. A partial symbol matrix among the rearranged symbols is set in a rotatable area. The partial symbol matrix is rotated in accordance with an operation signal inputted from an exterior and is thus rearranged. A payout is awarded which is determined by a combination of the symbols rearranged on a payline.

In the playing method of the slot machine of the invention, a partial symbol matrix among the rearranged symbols is set in a rotatable area. The partial symbol matrix is rotated in accordance with an operation signal inputted from the exterior and is thus rearranged. Then, a payout is awarded on the basis of a combination of the symbols rearranged on the payline.

The invention provides a playing method of a slot machine having structures below. Symbols are rearranged. When it is made a predetermined unit game-number, a partial symbol matrix is selected among the rearranged symbols on the basis of an operation signal inputted from an exterior, and the symbol matrix is set in a rotatable area. The partial symbol matrix is rotated in accordance with the operation signal and is thus rearranged. A payout is awarded which is determined by a combination of the symbols rearranged on a payline.

In the playing method of the slot machine of the invention, when it is made a predetermined unit game-number, a partial symbol matrix is selected among the rearranged symbols on the basis of an operation signal inputted from the exterior, and the symbol matrix is set in a rotatable area. The partial symbol matrix is rotated in accordance with an operation signal inputted from the exterior and is thus rearranged. Then, a payout is awarded on the basis of a combination of the symbols rearranged on the payline.

The invention provides a playing method of a slot machine having structures below. It is received an operation signal outputted from a touch panel provided to a front of symbols. A partial symbol matrix is selected among the rearranged symbols on the basis of the operation signal and the symbol matrix is set in a rotatable area. The partial symbol matrix is rotated in accordance with the operation signal and is thus rearranged. A payout is awarded which is determined by a combination of the symbols rearranged on a payline.

In the playing method of the slot machine of the invention, a partial symbol matrix is selected among the rearranged symbols on the basis of an operation signal inputted from a touch panel, and the symbol matrix is set in a rotatable area. The partial symbol matrix is rotated in accordance with the operation signal inputted from the touch panel and is thus rearranged. Then, a payout is awarded on the basis of a combination of the symbols rearranged on the payline.

The invention provides a playing method of a slot machine having structures below. It is received an operation signal outputted from a touch panel provided to a front of symbols. Symbols are rearranged. When it is made a predetermined unit game-number, a partial symbol matrix is selected among the rearranged symbols on the basis of the operation signal, and the symbol matrix is set in a rotatable area. The partial symbol matrix is rotated in accordance with the operation signal and is thus rearranged. A payout is awarded which is determined by a combination of the symbols rearranged on a payline.

When it is made a predetermined unit game-number, a partial symbol matrix is selected among the rearranged symbols on the basis of the operation signal inputted from a touch panel, and the symbol matrix is set in a rotatable area. The partial symbol matrix is rotated in accordance with the operation signal inputted from the touch panel and is thus rearranged. A payout is awarded which is determined by a combination of the symbols rearranged on a payline.

### BRIEF DESCRIPTION OF THE DRAWINGS

FIG. 1 illustrates a playing method of a slot machine;

FIG. 2 is a block diagram of a slot machine;

FIG. 3 illustrates a display screen;

FIG. 4 illustrates a display screen;

FIG. 5 illustrates a display screen;

FIG. 6 illustrates a display screen;

FIG. 7 shows symbols and code numbers thereof;

FIG. 8 is a perspective view showing an external appearance of a slot machine;

FIG. 9 is a block diagram showing a control circuit of a slot machine;

FIG. 10 illustrates a scatter symbol setting table;

FIG. 11 is a flow chart of a game executing process; and

FIG. 12 is a flow chart of a symbol rotating process.

### DESCRIPTION OF THE PREFERRED EMBODIMENTS

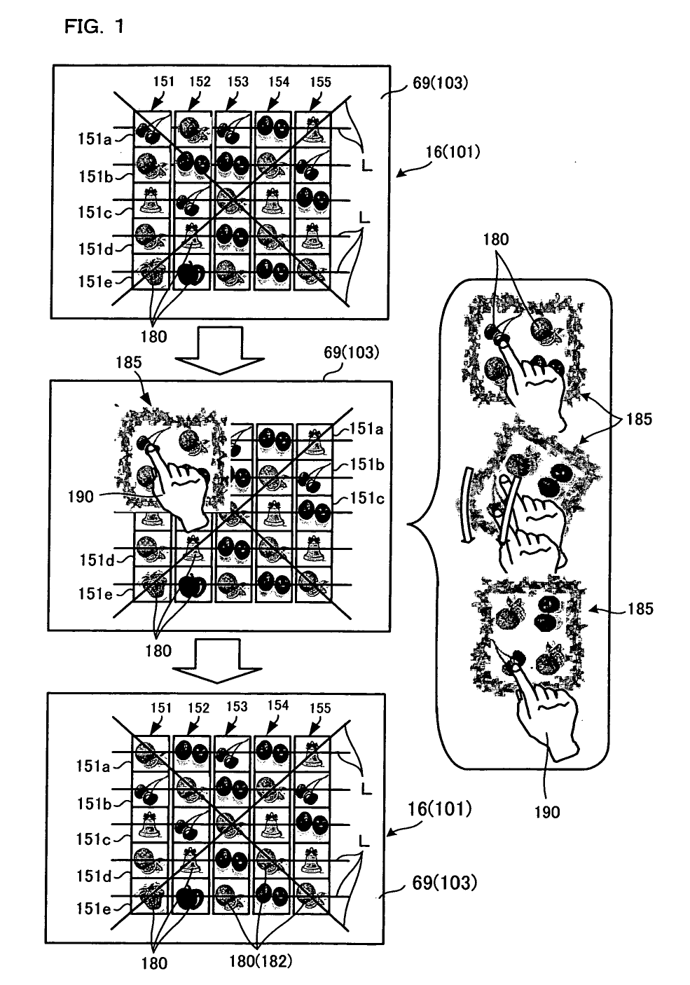

It will be described an embodiment of a slot machine and a playing method thereof according to the invention. As shown in FIG. 1, a slot machine executes a playing method comprising steps of rearranging symbols 180 arranged, setting, among the rearranged symbols 180, a partial symbol matrix in a rotatable area 185, rotating the partial symbol matrix in accordance with an operation signal inputted from an exterior to rearrange it, and awarding a payout determined by a combination of the symbols 180 rearranged on a payline L.

Further, the slot machine 10 executes a playing method comprising steps of selecting a partial symbol matrix based on an operation signal inputted from an exterior, setting the partial symbol matrix in a rotatable area 185 when it is made a predetermined unit game-number, and making a signal outputted from a touch panel 69 provided to a front of the symbols 180.

In addition, the slot machine 10 executes a playing method comprising steps of when a rearrangement-number of the symbols 180 of a same type rearranged on and out of a payline L is a set threshold value (for example, “8”) or more, setting the symbol 180 of the type as a scatter symbol 182, and awarding a payout determined on the basis of the scatter symbol 182.

Herein, the “arrangement” means a state in which the symbols 180 including the scatter symbol 182 are allowed to be visible with naked eyes of an exterior player. In other words, in FIG. 1, the symbols 180 are under state of being displayed in the display windows 151˜155. In the mean time, the “rearrangement” is meant by arranging the symbols 180 again after dismissing the arrangement of the symbols 180. The “rearrangement-number” is meant by the number of the rearranged symbols 180 of a same type. In FIG. 1, a rearrangement-number of “CHERRY” is “4.” A rearrangement-number of “BELL” is “5.”

In addition, the “payline” L is provided to determine a combination of the symbols 180. In other words, when the symbols 180 are rearranged on and out of the payline L, a combination is determined for only the symbols 180 rearranged on the payline. As a result of the determination for a combination, when it is made a winning combination, it is carried out, for example, a process of paying out a coin in accordance with the winning combination.

In addition, the “scatter symbol” 182 is a symbol making it a condition that a winning is made through only the rearrangement thereof, irrespective of the payline L. In other words, when the scatter symbol 182 is rearranged, a winning is made and it is carried out, for example, a process of paying out a coin on the basis of the number of all the scatter symbols 182 rearranged on and out of the payline L. Furthermore, the “symbol” is meant by all symbols used in the slot machine 10 and includes the scatter symbol 182 and a selection object symbols 181.

Further, the “partial symbol matrix” is meant by a combination of the symbols 180 which are arranged into a square matrix pattern, in which the numbers of column and row are same, from a structure in which the plural symbols 180 are arranged in a matrix pattern. In other words, in FIG. 1, a “partial symbol matrix” consisting of 2 rows 2 column is structured by a combination of the symbols 180 consisting of “CHERRY” in the first row and first column, “ORANGE” in the first row and the second column, “ORANGE” in the second row and the first column and “PLUM” in the second row and the second column. In the mean time, the partial symbol matrix is not limited to 2 rows 2 column and any square matrix may be applied. The payline L, the symbol 180, the scatter symbol 182 and the winning combination will be more specifically described later.

(Display Unit 101)

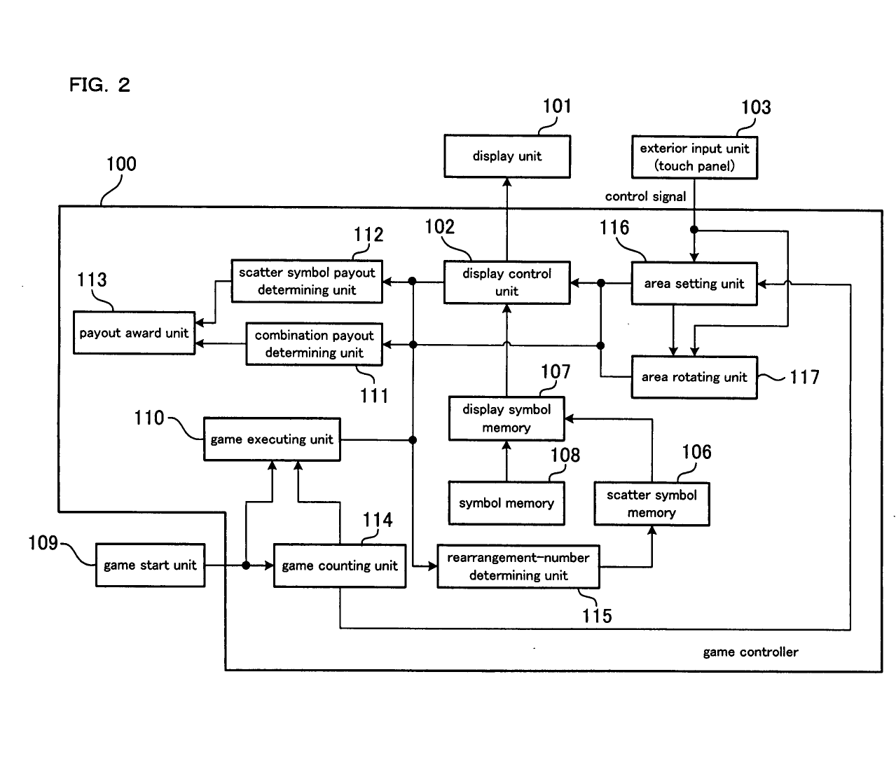

As shown in FIG. 2, the slot machine executing the above playing method is provided with a display unit 101 (display) and a game controller 100. The display unit 101 is structured to have the payline L and to arrange the plural symbols 180 in a matrix pattern.

The display unit 101 may be a mechanical structure with a reel device for arranging the symbols 180 by rotation of a reel or electrical structure with a video reel on which an image is displayed for arranging the symbols. Further, the display unit 101 may be a structure of combining a mechanical structure (reel) and an electrical structure (video reel). The electrical structure may include a liquid crystal device, a CRT (cathode-ray tube), a plasma display and the like. A detailed structure of the display unit 101 will be described later.

(Game Controller 100)

The game controller 100 is structured to execute a first process of rearranging the symbols 180, a second process of setting, among the rearranged symbols 180, a partial symbol matrix in a rotatable area 185, a third process of rotating the partial symbol matrix in accordance with an operation signal inputted from an exterior to rearrange it and a fourth process of awarding a payout determined by a combination of the symbols 180 rearranged on the payline L. In other words, the game controller 100 has a first processing unit, a second processing unit, a third processing unit and a fourth processing unit.

Further, the game controller 100 is structured to execute a fifth process of selecting a partial symbol matrix based on an operation signal inputted from the exterior and a sixth process of setting the partial symbol matrix in the rotatable area 185 when a unit games is repeated by the predetermined number of times. In other words, the game controller 100 has a fifth processing unit and a sixth processing unit, in addition to the first to fourth processing units. In the mean time, the game controller 100 is not limited to the structure of executing the fifth and sixth processes.

In other words, the game controller 100 itself may automatically select a partial symbol matrix. The symbol matrix may be randomly selected or a predetermined matrix may be selected. In addition, the game controller 100 may set a partial symbol matrix in the rotatable area 185 every unit game.

The game controller 100 is provided with a scatter symbol memory 106 for storing the scatter symbol 182, a symbol memory 108 for storing all the symbols 180 and a display symbol memory 107 for storing the symbols in the respective memories 106, 108 as a display symbol. The display symbol memory 107 can be accessed by a display control unit 102. The display control unit 102 reads out a symbol of the display symbol memory 107 under control of a game executing unit 110 and displays the plural symbols in a matrix pattern. A specific display state will be described later.

In addition, the game controller 100 has a rearrangement-number determining unit 115 and a game counting unit 114. The rearrangement-number determining unit 115 has functions of acquiring a rearrangement-number of each symbol 180, comparing a rearrangement-number and a set threshold value (for example, “8”) and storing the symbol 180, which is rearranged by a rearrangement-number same as or greater than a set threshold value, into the scatter symbol memory 106 as a scatter symbol 182. The game counting unit 114 has a function of counting the number of unit games after a predetermined condition is fulfilled.

Further, the game controller 100 has an area setting unit 116 and an area rotating unit 117. To each of the units 116, 117 are inputted an operation signal from an exterior input unit 103 and a unit game-number signal from the game counting unit 114. The exterior input unit 103 is mounted separately from the game controller 100 and receives an input of a selection signal from the exterior, which is made by a player. In the mean time, the exterior input unit 103 may be a touch panel provided to the display unit 101 or a mouse or operative button.

The area setting unit 116 has functions of specifying a symbol 180 which is designated by an operation signal from the exterior input unit 103 and setting a rotatable area 185 surrounding a symbol matrix of 2 rows 2 columns including the specified symbol 180. In the mean time, when there is a plurality of the rotatable areas 185 surrounding the specified symbol 180, the areas are switched whenever an operation signal is inputted. The area rotating unit 117 has functions of turning the rotatable area 185 toward right or left by 90, based on the operation signal, and rearranging the symbol 180 of the rotatable area 185 into a state after rotation. Here, the “rearrangement into a state after rotation” is meant by rearranging the symbol 180 rearranged at a matrix position before rotation into a matrix position after rotation. Specifically, in case of turning the rotatable area 185 toward left by 90, a symbol 180 of the first row and the first column is rearranged at a position of the second row and the first column.

The area setting unit 116 and the area rotating unit 117 have a function of executing an operation shown in FIG. 1 when a unit game-number in the game counting unit 114 becomes a predetermined number. In other words, when the player 190 pushes the touch panel 69, a rotatable area 185 including a specified symbol 180 appears. Then, when the area is dragged with the pushed state maintained, the rotatable area 185 is rotated in the drag direction by 90. When the drag is continued, the area is further rotated by 90. When the push is released, the rotating operation of the rotatable area 185 is ended and the symbol 180 of the rotatable area 185 is rearranged into a state after rotation.

Further, the game controller 100 is connected to a game start unit 109. The game start unit 109 has a function of outputting a game start signal in accordance with control of the player. The game controller 100 comprises a game executing unit 110 for executing a unit game rearranging the symbols 180 with an input of a game start signal, as trigger, from the game start unit 109, a combination payout determining unit 111 for determining a payout determined by a combination of the symbols 180 rearranged on the payline L in a unit game, a scatter symbol payout determining unit 112 for determining a payout on the basis of the scatter symbols 182 rearranged on and out of the payline L and a payout award unit 113 for awarding the respective payouts determined in the combination payout determining unit 111 and the scatter symbol payout determining unit 112.

In the mean time, each block of the game controller 100 may be structured with a hardware or software, as required.

(Operation of Game Controller 100)

In the above structure, an operation of the game controller 100 is described. First, the plural symbols 180 are arranged in a matrix pattern of 5 rows 5 columns in the display unit 101. When the game executing unit 110 starts a unit game through an operation of the game start unit 109, the symbols 180 are rearranged (first process). In case that the game counting unit 114 counts a predetermined unit game-number, the area setting unit 116 becomes under operation state (sixth process). Then, it is specified a symbol 180 which is designated by an operation signal from the exterior input unit 103, and it is set a rotatable area 185 surrounding a symbol matrix of 2 rows 2 columns including the specified symbol 180 (second process). Based on an operation signal from the exterior input unit 103, the rotatable area 185 is turned right or left by 90 (fifth process). Then, the respective symbols 180 of the rotatable area 185 are rearranged into a state after rotation (third process).

Next, with respect to the rearranged symbols 180, it is acquired a rearrangement-number of each symbol 180. The rearrangement-number and the set threshold value (for example, “8”) are compared. The symbol 180, which is rearranged by a rearrangement-number same as or greater than the set threshold value, is stored into the scatter symbol memory 106 as a scatter symbol 182.

Then, a payout, which is determined by a combination of the symbols 180 rearranged on the payline, is awarded by the scatter symbol payout determining unit 112 and the payout award unit 113. In the mean time, a payout, which is determined on the basis of the scatter symbols 182 rearranged on and out of the payline L, is awarded by the combination payout determining unit 111 and the payout award unit 113. Thereby, the game controller 100 executes the fourth process of rearranging the symbols to award a payout determined by a combination of symbols 180 rearranged on the payline L and the process of awarding a payout determined on the basis of the scatter symbols 180 rearranged on and out of the payline.

As can be clearly seen from the above operation, the slot machine 10 embodies the playing method of rearranging the symbols 180, as shown in FIG. 1, setting, among the rearranged symbols 180, a partial symbol matrix in the rotatable area 185, rotating the partial symbol matrix in accordance with an operation signal inputted from the exterior to rearrange it and awarding a payout determined by a combination of the symbols 180 rearranged on the payline L. Further, the slot machine 10 embodies a playing method of selecting a partial symbol matrix based on an operation signal inputted from the exterior, a playing method of setting a partial symbol matrix in the rotatable area 185 when it is made a predetermined unit game-number and a playing method of making a signal, which is outputted from the exterior input unit 103 (touch panel, etc.) provided to a front of the symbols 180, as an operation signal.

(Display State)

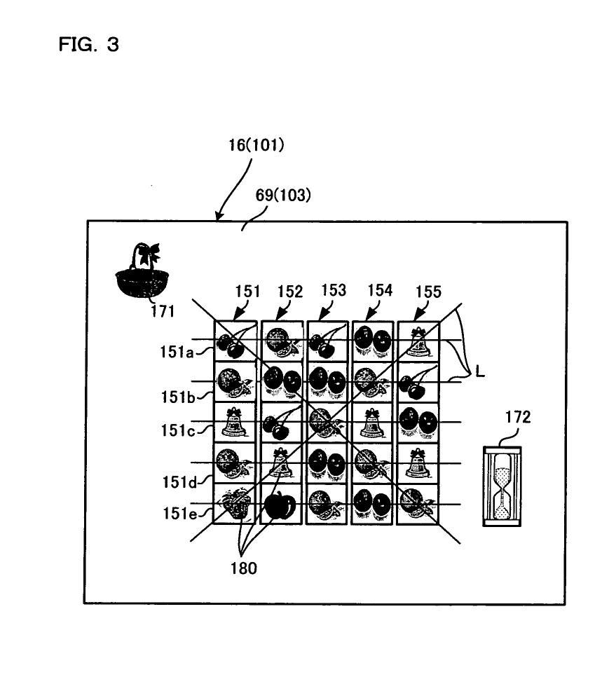

It is specifically described an example of a display state of the display unit 101, with respect to the operation processes of the slot machine 10 and the playing method. In the mean time, as shown in FIGS. 3 to 6, the display state is described with reference to a structure in which the display unit 101 arranges the symbols with a video reel manner and a touch panel 69 (exterior input unit 103) is provided to a display surface of the display unit 101.

The display unit 101 has display windows 151˜155 as the arrangement area for arranging the plural symbols. The display windows 151˜155 are arranged in a central part of the display unit 101. In the display windows 151˜155, symbol columns consisting of the plural symbols 180 are scroll-displayed. In addition, each of the display windows 151˜155 is divided into a top stage 151a, an upper stage 151b, a center stage 151c, a lower stage 151d and a bottom stage 151e. Each of the symbols 180 is stopped (arranged) in the respective stages 151a˜151e. For example, in FIG. 3, “CHERRY” is stopped in the top stage 151a of the display window 151, “ORANGE” is stopped in the upper stage 151b thereof, “BELL” is stopped in the center stage 151c thereof, “ORANGE” is stopped in the lower stage 151d thereof and “STRAWBERRY” is stopped in the bottom stage 151e thereof. In other words, the display windows 151˜155 display a symbol matrix consisting of 5 columns and 5 rows. In the mean time, the symbol matrix is not limited to 5 columns 5 rows.

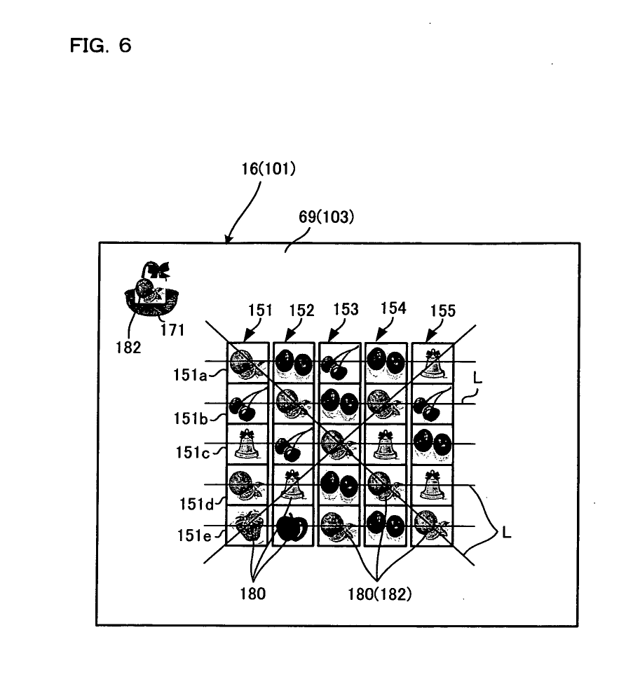

In addition, the display unit 101 has a scatter symbol display 171. The scatter symbol display 171 is basket-shaped, and displays the scatter symbol 182 as a received thing, as shown in FIG. 6. The scatter symbol display unit 171 is provided to a left-handed upper corner part of the display unit 101. In the mean time, the scatter symbol display unit 171 may be provided to an arbitrary position on condition that it can avoid the overlapping with the display windows 151˜155.

Further, the display unit 101 has an approval notifying unit 172. The approval notifying unit 172 is sandglass-shaped. The approval notifying unit 172 is displayed when the rotatable area 185 can be set and rotated, and a remaining amount of sand thereof indicates a rotatable remaining time. In the mean time, the approval notifying unit 172 may be such structured that an analog or digital watch indicates the remaining time.

In the display unit 101 structured as described above, a display state of FIG. 3 shows a state in which a partial symbol matrix can be designated to set the rotatable area 185 after the symbols 180 are rearranged. In other words, after the symbols 180 are rearranged in the display windows 151˜155, the approval notifying unit 172 appears before a payout is awarded on the basis of a combination of the symbols 180, etc. Thereby, the player can intuitively recognize that the player can set and rotate the rotatable area 185, by observing the approval notifying unit 172 with naked eyes.

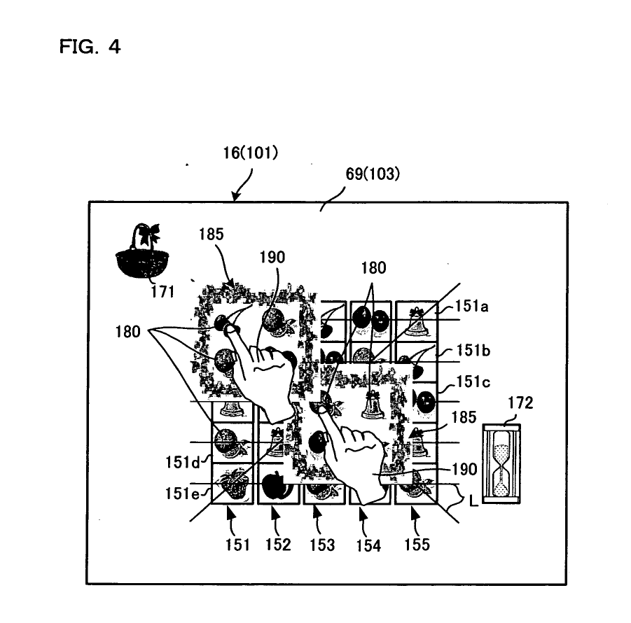

A display state of FIG. 4 shows a state of setting the rotatable area 185. In other words, when the player 190 pushes a desired symbol 180, the touch panel 69 generates an operation signal which indicates the position information. Then, it is extracted a partial symbol matrix of 2 rows 2 columns including the symbol 180 which is specified on the basis of the position information of the operation signal. Then, it is set a rotatable area 185 surrounding the partial symbol matrix.

More specifically, in case that the player 190 pushes “CHERRY” of the first row and the first column, it is set a rotatable area 185 surrounding the symbol matrix of 2 rows 2 columns including “CHERRY.” At this time, in case of designating the symbol 180 of the first row and the first column, there is only one combination of the symbol matrix of 2 rows 2 columns. Accordingly, when the player 190 pushes again, the same rotatable area 185 is displayed.

In the mean time, in case that the player 190 pushes “ORANGE” of the third row and the third column, it is set a rotatable area 185 surrounding the symbol matrix of 2 rows 2 columns including “ORANGE.” At this time, in case of designating the symbol 180 of the third row and the third column, there are four combinations of the symbol matrix of 2 rows 2 columns. Accordingly, when the player 190 pushes again, a rotatable area 185 surrounding another type of a symbol matrix is displayed.

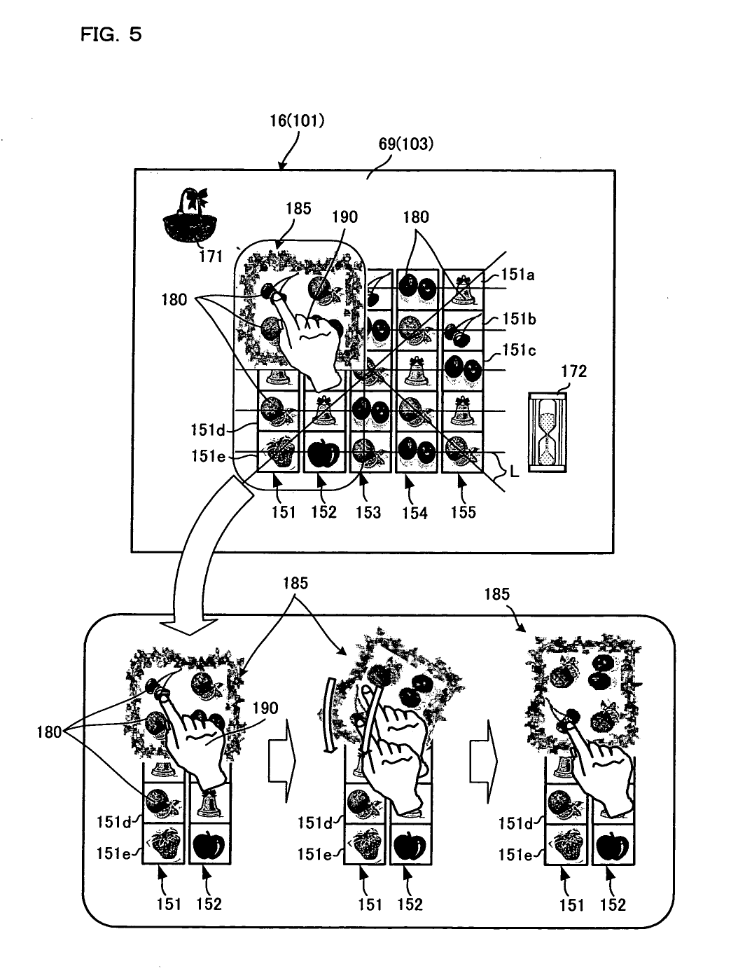

A display state of FIG. 5 shows a state of rotating the rotatable area 185. In other words, in case that a rotatable area 185 is set, when the player 190 drags it while pushing the touch panel 69, the rotatable area 185 is rotated in the drag direction. Thereby, since the rotatable area 185 is rotated in connection with the drag, the player can intuitively recognize that the player can rotate a partial symbol matrix in a rotation direction which the player expects.

A display state of FIG. 6 shows a state after the rotatable area 185 is rotated counterclockwise by 90. That is, “CHERRY” of the first row and the first column is set in the second row and the first column. “ORANGE” of the second row and the first column is set in the second row and the second column. “PLUM” of the second row and the second column is set in the first row and the second column. “ORANGE” of the first row and the second column is set in the first row and the first column. Thereby, the symbol 180 of “ORANGE” is arranged in series on the paylines L, so that a winning combination of “ORANGE” is made.

(Symbol, Combination, etc.)

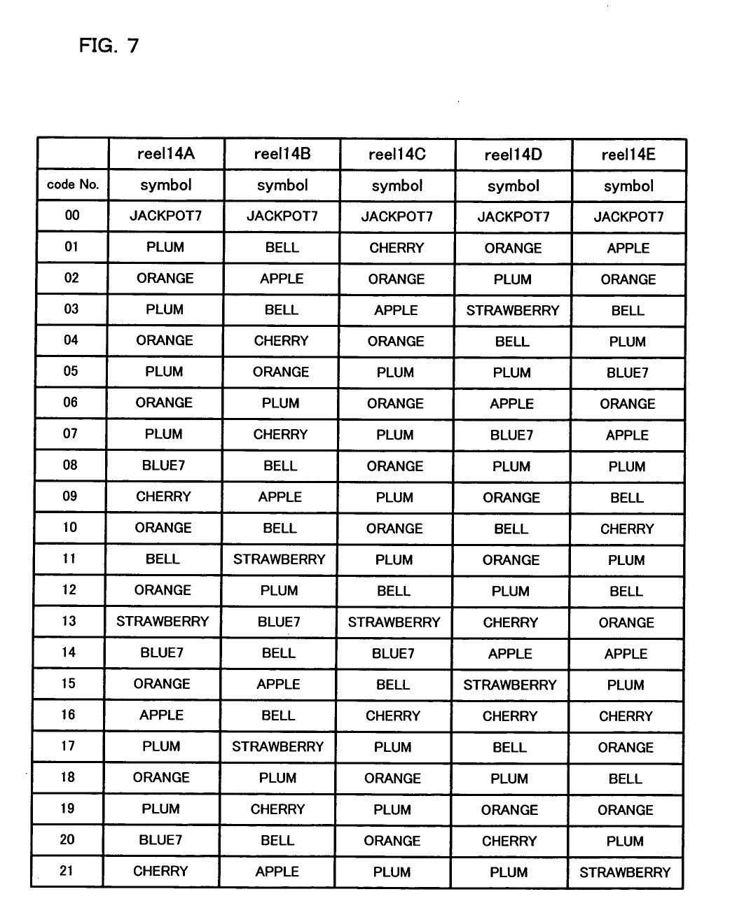

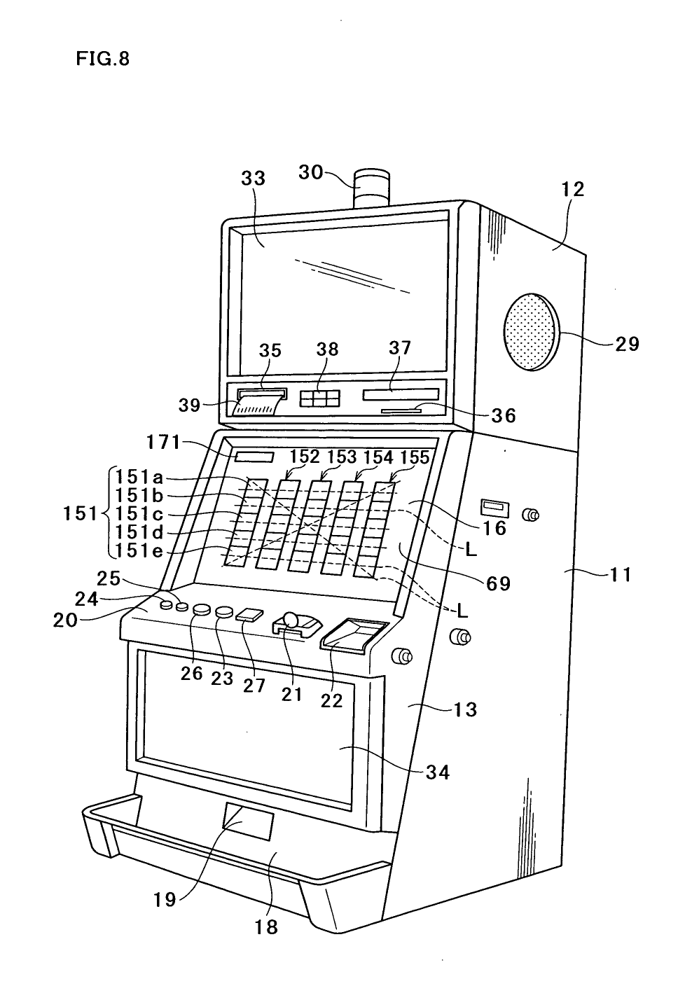

As shown in FIG. 8, the symbols 180 to be displayed in the display windows 151˜155 of the display unit 101 constitute a column of symbols by 22 symbols, as shown in FIG. 7. The symbols constituting the respective columns of symbols are given with one code number of 0˜21. Each of the columns of symbols is constituted with a combination of symbols of “JACKPOT 7,” “BLUE 7,” “BELL,” “CHERRY,”“STRAWBERRY,” “PLUM,” “ORANGE” and “APPLE.”

The three successive symbols in the columns of symbols are displayed (arranged) in the top, upper, center, lower and bottom stages 151a, 151b, 151c, 151d, 151e of the display windows 151˜155, respectively, so that they constitute a symbol matrix of 5 columns 5 rows. When a 1-BET button 26 or MAX-BET button 27 is pushed and then a spin button 23 is pushed, the symbols constituting the symbol matrix starts the scroll. When the scroll starts, the scrolls of the respective symbols are stopped (rearranged) after a predetermined time period has lapsed.

In addition, various winning combinations are predetermined with regard to the respective symbols. The winning combination is a combination that a combination of symbols stopped on the payline L becomes an advantageous state to the player. The advantageous state is a state in which a coin is paid out in accordance with the winning combination, a state in which the payout-number of coins is added to a credit, a state in which a bonus game is started, and the like.

Specifically, when a combination of “APPLE” symbol is stopped on the payline L, a bonus is triggered and a gaming state is shifted to a bonus game from a basic game. In addition, when a symbol of “CHERRY” is stopped on the payline L, 20 coins (game medium) are paid out per one bet. When a symbol of “PLUM” is stopped on the payline L, 5 coins are paid out per one bet.

In the mean time, a bonus game is a gaming state that is more advantageous than a basic game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the basic game. For example, the bonus game may include a state in which it is possible to obtain more game medium than the basic game, a state in which it is possible to obtain a game medium in a higher probability than in the basic game, a state in which a game medium is less consumed than in the basic game, and the like. Specifically, a free game, a second game and the like are examples of the bonus game.

(Mechanical Structure)

In the followings, it will be described an example of the slot machine structured in a mechanical and electrical manner.

As shown in FIG. 8, the slot machine 10 is provided in a game arcade. The slot machine 10 executes a unit game by using a game medium. The game medium is a coin, bill or electronic negotiable information corresponding to them. Meanwhile, in the invention, the game medium is not particularly limited. For example, a medal, token, electronic money, ticket and the like can be used. The ticket is not particularly limited and may be a ticket with a barcode which will be described later.

The slot machine 10 comprises a cabinet 11, a top box 12 provided to an upper part of the cabinet 11 and a main door 13 provided to a front of the cabinet 11. The main door 13 is provided with a lower image display panel 16. The lower image display panel 16 has a transparent liquid crystal panel for displaying a variety of information. The lower image display panel 16 displays a video reel and a variety of information and effect images relating to a game. Specifically, the lower image display panel 16 displays the display windows 151˜155 of 5 columns/5 rows, the selection windows 161, 162, 163 and the scatter symbol display unit 171, as shown in FIG. 1, and other effect images, as required.

In the mean time, in this embodiment, it is exemplified a case where the symbols 180 of 5 columns/5 rows are displayed with the lower image display panel 16. However, the invention is not limited thereto. For example, a mechanical reel having symbols provided to a periphery thereof may be rotated and stopped to display symbols which are beyond a display window 15.

Seven activated paylines L are displayed in the lower image display panel 16. The paylines L are set to horizontally traverse the top, upper, center, lower and bottom stages 151a, 151b, 151c, 151d, 151e of the display windows 151˜155 and also to diagonally traverse in right and left inclined directions. Meanwhile, all of the paylines L may be activated. Alternatively, the paylines L corresponding to a predetermined condition such as bet number of coins may be activated. In addition, in this embodiment, the paylines L traverse all the stages 151a˜151e of the display windows 151˜155. However, the paylines L may traverse any stages of the display windows 151˜155. For example, the paylines L may traverse the top stages 151a or bottom stages 151e of the display windows 151˜155.

In the mean time, a credit-number display unit and a payout-number display unit may be displayed in the lower image display panel 16. The credit-number display unit displays a total number that the slot machine 10 can pay out to a player (which will be referred to as total credit-number). The payout-number display unit displays number of coins to be paid out when a combination of symbols stopped on the payline L is a winning combination.

A touch panel 69 is provided to a front surface of the lower image display panel 16. The touch panel 69 has plural contact points in a matrix form of longitudinal and transverse directions and allows position information, which indicates longitudinal and transverse positions of the pressed contact points, to be outputted as a command signal. In the mean time, the touch panel 69 may be a touch panel adopted in a mobile terminal or ATM of a bank.

A control panel 20, a coin receiving slot 21 and a bill validator 22 are provided below the lower image display panel 16. The control panel 20 is provided with plural buttons 23˜27. The buttons 23˜27 allows instructions, which are related to a game progress by a player, to be inputted. The coin receiving slot 21 enables a coin to be received in the cabinet 11.

The control panel 20 is provided with a spin button 23, a change button 24, a cash out button 25, a 1-BET button 26 and a MAX-BET 27. The spin button 23 is a button for inputting an instruction to start the scroll of symbols. The change button 24 is a button to be used when a player asks a staff in the game arcade for exchange of money. The cash out button 25 is a button for inputting an instruction to pay out the coins of total credit-number into a coin tray 18.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

The bill validator 22 validates whether bill is normal or not and receives the normal bill into the cabinet 11. In the mean time, the bill validator 22 can read a ticket 39 having a barcode which will be described later. When the bill validator 22 reads the ticket 39 having a barcode, it outputs a reading signal relating to the read content to a main CPU 41.

A belly glass 34 is provided to a lower front surface of the main door 13, i.e., below the control panel 20. A character of the slot machine 10 and the like are drawn on the belly glass 34. An upper image display panel 33 is mounted to a front of the top box 12. The upper image display panel 33 has a liquid crystal panel and displays, for example, an effect image and an image indicating an introduction of a game content and an explanation of a game rule.

To the top box 12 is mounted a speaker 29 for outputting voice. A ticket printer 35, a card reader 36, a data displayer 37 and a keypad 38 are provided below the upper image display panel 33. The ticket printer 35 prints a barcode having data encoded thereto, such as credit-number, date and time, identification number of the slot machine 10 and the like, onto a ticket, thereby outputting the ticket 39 having the barcode. The player can play a game in another slot machine with the ticket 39 having a barcode and exchange the ticket 39 having a barcode with bill in a change booth of the game arcade.

The card reader 36 reads and writes the data from and into a smart card. The smart card is a card carried by a player, into which data for identifying the player and data relating to a game history of the player are memorized.

The data displayer 37 consists of a fluorescent display and the like, and displays the data read by the card reader 36 and the data inputted by the player through the keypad 38. The keypad 38 inputs instructions or data relating to a ticket issue.

(Electrical Structure)

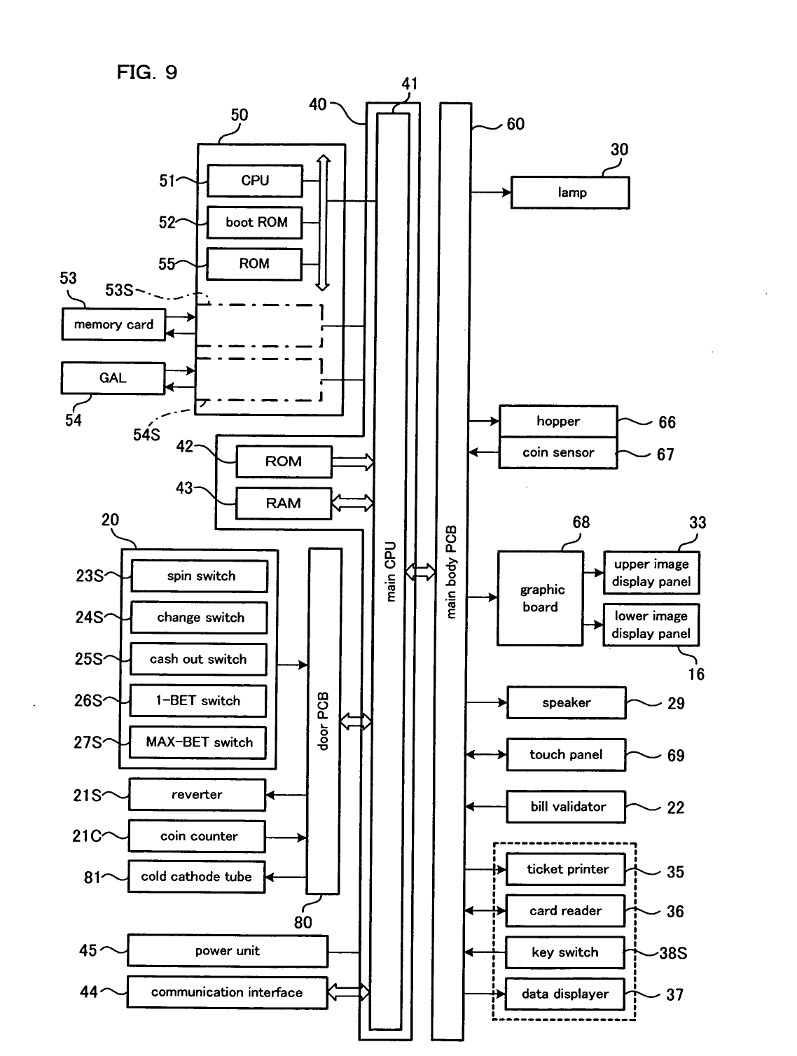

A control unit having the game controller 100 shown in FIG. 2 is mounted in the cabinet 11. As shown in FIG. 9, the control unit comprises a motherboard 40, a main body PCB (Printed Circuit Board) 60, a gaming board 50, a sub CPU, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol (code number corresponding to the symbol) to be stopped on the payline L. The stop symbol determining program includes symbol weight data corresponding to each of plural payout rate (for example, 80%, 84%, 88%). The symbol weight data is data representing a correspondence relation between the code number of each symbol and 1 or plural random numbers belonging to a predetermined numerical range (0˜256) for each of the display windows 151˜155.

The payout rate is determined on the basis of data for setting a payout rate, which data is outputted from the GAL 54, and a stop symbol is determined on the basis of the symbol weight data corresponding to the payout rate.

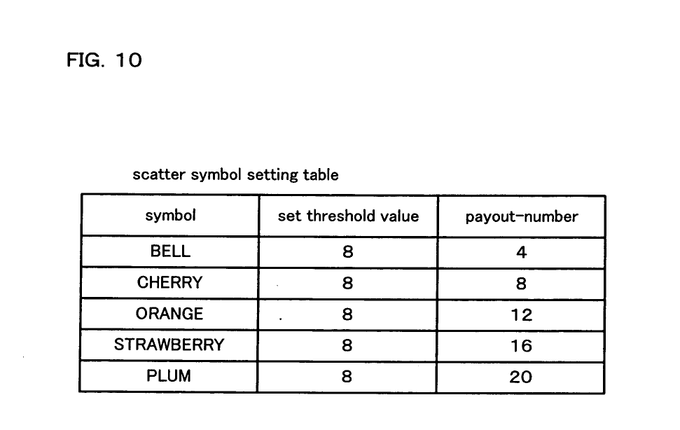

Further, the memory card 53 stores various data used for the game program and the game system program. Specifically, the data representing a relationship between the symbols 180 displayed in the display windows 151˜155 of FIG. 1 and the code numbers is stored in a data table form shown in FIG. 7. In addition, the data representing a relationship of a symbol, a scatter symbol and a payout-number (payout) is stored in a scatter symbol setting table form shown in FIG. 10. The data table in FIG. 10 will be specifically described later. In the mean time, these data are transmitted to a RAM 43 of the motherboard 40 when executing the game program.

In addition, the card slot 53S is structured to insert and remove the memory card 53 and connected to the motherboard 40 through an IDE bus. Accordingly, it is possible to change a type or content of a game to be executed in the slot machine, by removing the memory card 53 from the card slot 53S, writing another game program and game system program in the memory card 53 and inserting the memory card 53 into the card slot 53S.

The game program includes a program relating to a game progress and a program for shifting a gaming state into a bonus game.

The GAL 54 is provided with plural input and output ports. When the data is inputted into the input ports, the GAL 54 outputs data corresponding to the inputted data from the output ports. The data outputted from the output ports is the data for setting a payout rate which has been described above.

The IC socket 54S is structured to attach and detach the GAL 54. The IC socket 54S is connected to the motherboard 40 through a PCI bus. Accordingly, it is possible to change the data for setting a payout rate which is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication interface 44.

The main CPU 41 has functions of a controller for controlling the whole slot machine 10. In particular, the main CPU 41 carries out a control for outputting a command signal enabling the sub CPU to scroll the symbols of the lower image display panel 16 when the spin button 23 is pushed after the credit is bet, a control for determining symbols to be stopped after the symbols are scrolled and a control for stopping the determined symbols in the display windows 151˜155.

In other words, the main CPU 41 has functions of an arrangement controller for selecting and determining arrangement symbols with regard to a symbol matrix from the plural types of symbols so as to rearrange them, as a new symbol matrix after scrolling the plural symbols to be displayed in the lower image display panel 16, and executing an arrangement control which will be stopped at the determined symbols from the scroll state.

In addition, the motherboard 40 has functions of the game controller 100 for executing a first process of rearranging the symbols 180, a second process of setting, among the symbols 180 rearranged, a partial symbol matrix in a rotatable area 185, a third process of rotating the partial symbol matrix in accordance with an operation signal inputted from an exterior to rearrange it, and a fourth process of awarding a payout determined by a combination of the symbols 180 rearranged on the payline L.

Further, the motherboard 40 has functions of the game controller 100 for executing a fifth process of selecting a partial symbol matrix based on an operation signal inputted from the exterior and a sixth process of setting the partial symbol matrix in the rotatable area 185 when a unit games is repeated by the predetermined number of times.

The ROM 42 stores a program such as BIOS (Basis Input/Output System) executed by the main CPU 41, and data that is permanently used. When the BIOS is executed by the main CPU 41, each of peripheral devices is initialized and the game program and the game system program stored in the memory card 53 are read out through the gaming board 50.

The RAM 43 stores the data or program used when the CPU 41 carries out a process. For example, in the RAM 43, the scatter symbol memory 106, the symbol memory 108, the display symbol memory 107 and the like shown in FIG. 2 are respectively provided in a data area form. The data area of the scatter symbol memory 106 stores the scatter symbol 182. The data area of the symbol memory 108 stores the symbols 180 in the data table form shown in FIG. 7. The data area of the display symbol memory 107 stores the symbols 180 and the scatter symbol 182.

The communication interface 44 is provided to communicate with a host computer and the like through a communication line, which are mounted in the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are connected to a device or apparatus for producing an input signal which will be inputted to the main CPU 41, and a device or apparatus which is controlled by the control signal outputted from the main CPU 41. The main CPU 41 executes the game program and the game system program stored in the RAM 43, based on the input signal inputted to the main CPU 41 to carry out an arithmetic process, thereby storing a result thereof in the RAM 43 or transmitting a control signal to each device or apparatus to control it.

The main body PCB 60 is connected with a lamp 30, the sub CPU, a hopper 66, a coin sensor 67, a graphic board 68, the speaker 29, the touch panel 69, the bill validator 22, the ticket printer 35, the card reader 36, a key switch 38S and the data displayer 37.

The lamp 30 is turned on/off on the basis of the control signal outputted from the main CPU 41. The sub CPU controls the scroll of symbols of the display windows 151˜155 and is connected to a VDP (Video Display Processor). The VDP reads out image data of the symbol stored in an image data ROM 47, produces a scroll image to be displayed in the display windows 151˜155 and outputs the scroll image in the lower image display panel 16.

The hopper 66 is mounted in the cabinet 11 and pays out predetermined number of coins to the coin tray 18 from the coin payout slot 19, based on the control signal outputted from the main CPU 41. The coin sensor 67 is mounted in the coin payout slot 19 and outputs an input signal to the main CPU 41 when it detects that the predetermined number of coins are paid out from the coin payout slot 19.

The graphic board 68 controls an image display in the upper image display panel 33 and the lower image display panel 16, based on the control signal outputted from the main CPU 41. In addition, the graphic board 68 is provided with a VDP for producing image data on the basis of the control signal outputted from the main CPU 41, a video RAM for temporarily storing the image data produced by the VDP, and the like.

The bill validator 22 reads an image of the bill and accommodates the normal bill in the cabinet 11. In addition, in accommodating the normal bill, the bill validator 22 outputs an input signal to the main CPU 41, based on an amount of the bill. The main CPU 41 stores a credit-number, which corresponds to the amount of the bill transmitted by the input signal, in the RAM 43.

The ticket printer 35 prints a barcode having data encoded thereto, such as credit-number stored in the RAM 43, date and time, identification number of the slot machine 10 and the like, on a ticket, based on the control signal outputted from the main CPU 41, thereby outputting the ticket 39 having the barcode.

The card reader 36 reads the data from the smart card to transmit it to the main CPU 41, and writes the data into the smart card, based on the control signal outputted from the main CPU 41. The key switch 38S is mounted to the keypad 38, and outputs an input signal to the main CPU 41 when the player manipulates the keypad 38. The data displayer 37 displays the data which is read by the card reader 36 or the data which the player inputs through the keypad 38, based on the control signal outputted from the main CPU 41.

The door PCB 80 is connected with the control panel 20, a reverter 21S, a coin counter 21C and a cold cathode tube 81. The control panel 20 is provided with a spin switch 23S corresponding to the spin button 23, a change switch 24S corresponding to the change button 24, a cash out switch 25S corresponding to the cash out button 25, a 1-BET switch 26S corresponding to the 1-BET button 26 and a MAX-BET switch 27S corresponding to the MAX-BET button 27. Each of the switches 23S˜27S outputs an input signal to the main CPU 41 when each of the corresponding buttons 23˜27 is pushed by a player.

The coin counter 21C is mounted in the coin receiving slot 21 and validates whether a coin, which is inserted in the coin receiving slot 21 by the player, is normal or not. A coin except the normal coin is discharged from the coin payout slot 19. In addition, the coin counter 21C outputs an input signal to the main CPU 41 when it detects a normal coin.

The coin counter 21C is operated on the basis of the control signal outputted from the main CPU 41 and distributes a coin, which is recognized as a normal coin by the coin counter 21C, to a cash box (not shown) or hopper 66 mounted in the slot machine 10. In other words, when the hopper 66 is fully filled with the coins, the normal coin is distributed into the cash box by the reverter 21S. In the mean time, when the hopper 66 is not fully filled with the coins, the normal coin is distributed into the hopper 66. The cold cathode tube 81 functions as a backlight mounted to rear sides of the lower image display panel 16 and the upper image display panel 33 and is turned on, based on the control signal outputted from the main CPU 41.

(Data Table)

In the followings, it will be described a scatter symbol setting table in FIG. 10. The table has a column of symbols, a column of set threshold values and a column of payout-numbers. The column of symbols stores 5 types of symbols consisting of “BELL,” “CHERRY,” “ORANGE,”“STRAWBERRY” and “PLUM.” The column of set threshold values stores a value used to determine whether to allow a scatter symbol or not. Specifically, “8” is stored. Thereby, for example when a rearrangement-number (display number) of “CHERRY” is “8” which is a set threshold value or more, “CHERRY” is set as a scatter symbol. In the mean time, the set threshold value may be varied depending on the symbols. The column of payout-numbers stores a payout-number of coins to be paid out when a symbol is set as a scatter symbol. Specifically, when “BELL” is set as a scatter symbol, 4 coins are paid out.

(Processing Operation)

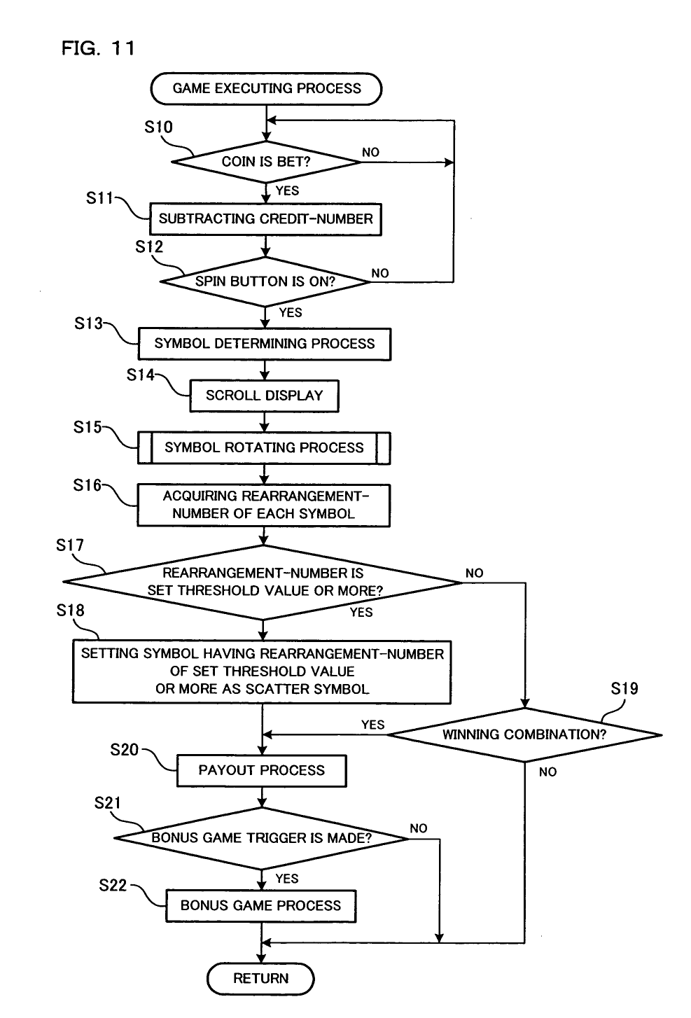

In the followings, it will be described a process which is carried out in the slot machine 10. When the main CPU 41 reads out and executes the game program, a game is started. As shown in FIG. 11, in the game executing process, it is determined whether a coin is bet (S10). In this process, it is determined whether it is received an input signal from the 1-BET switch 26S as the 1-BET button 26 is pushed and whether it is received an input signal from the MAX-BET switch 27S as the MAX-BET button 27 is pushed. When the coin is not bet (S10, NO), the step of S10 is re-executed and it is under standby state until a coin is bet.

In the mean time, when the coin is bet (S10, YES), the credit-number stored in the RAM 43 is subtracted, correspondingly to the number of coins bet (S11). Meanwhile, if the number of coins bet is larger than the credit-number stored in the RAM 43, it is not carried out the process of subtracting the credit-number and the step of S11 is re-executed. In addition, if the number of coins bet is above the upper limit (50 pieces in this embodiment) which can be bet per one game, it is not carried out the process of subtracting the credit-number and a step of S12 is carried out.

Next, it is determined whether the spin button 23 is ON or not (S12). When the spin button 23 is not ON (S13, NO), the procedure is returned to the step of S10. Meanwhile, in case that the spin button 23 is not ON (for example, the spin button 23 is not ON and an instruction to end the game is inputted), it is canceled the subtraction result in the step of S11.

In the mean time, when the spin button 23 is ON (S12, YES), a symbol determining process is executed (S13). In other words, a stop symbol determining program stored in the RAM 43 is executed, so that the symbols 180 which will be stopped in each of the twenty-five (25) stages 151a˜151e of the display windows 151˜155 are determined. Thereby, it is determined a combination of the symbols which will be stopped on the paylines L.

Then, the symbols 180 in the display windows 151˜155 are scroll-displayed (S14). Meanwhile, the scroll process is such that the symbols 180 are scrolled in an arrow direction and then the symbols 180 determined in the step of S13 are stopped (rearranged) in the display windows 151˜155.

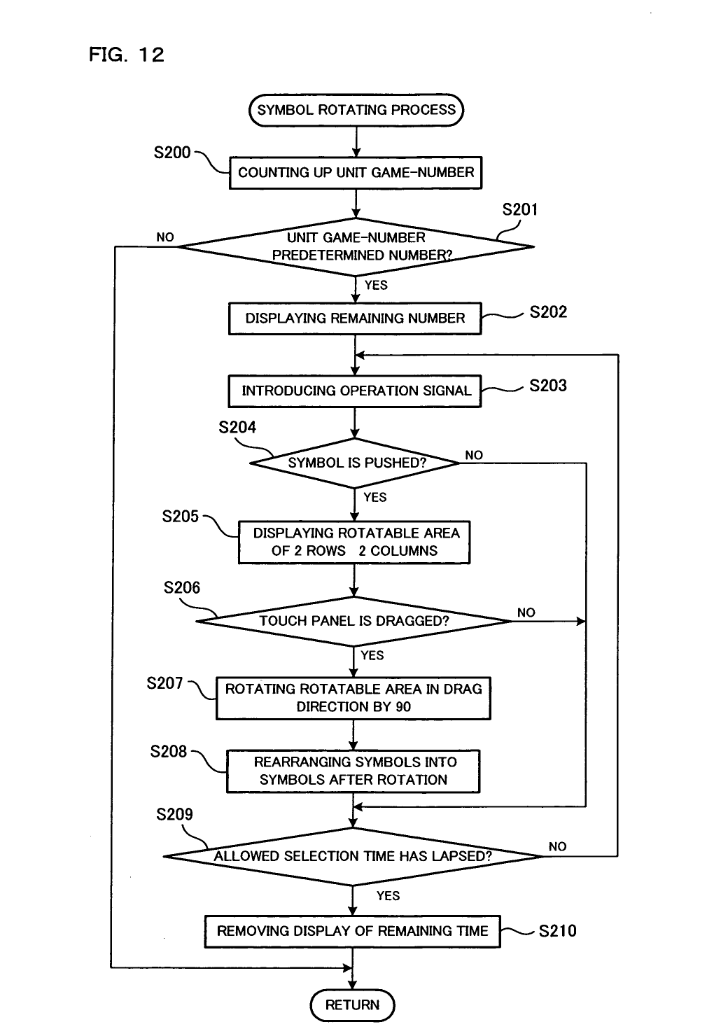

Next, a symbol rotating process is executed (S15). Specifically, a symbol rotating process routine in FIG. 12 is executed. First, in order to check how many times of the unit games have been executed from the previous rotating process, a unit game-number is counted-up (S200). Then, it is determined whether the unit game-number is a predetermined number or more (S201). When the unit game-number is not the predetermined number or more (S201, NO), this routine is ended and the process returns to the game executing process in FIG. 11.

In the mean time, when the unit game-number is the predetermined number or more (S201, YES), the approval notifying unit 172 having a sandglass shape is displayed as shown in FIG. 3, so that a rotatable remaining time (allowed time for rotation) is displayed (S202). After that, it is introduced an operation signal outputted from the touch panel 69 (S203). Then, it is determined whether the symbol 180 is pushed, on the basis of the operation signal (S204). When an operation signal is not outputted because the touch panel 69 is not pushed, or when the operation signal indicates that another part, rather than the symbol 180, is pushed (S204, NO), it is determined whether an allowed selection time has lapsed (S209). When the allowed selection time has not lapsed (S209, NO), the process is re-executed from the step of S203 and it is thus repeated the process that it is introduced an operation signal outputted from the touch panel 69. In the mean time, when the allowed selection time has lapsed (S209, YES), the display of the remaining time in the approval notifying unit 172 disappears (S210). Then, this routine is ended and the process returns to the game executing process in FIG. 11.

In addition, when the operation signal indicates that the symbol 180 is pushed (S204, YES), it is displayed a rotatable area 185 surrounding a symbol matrix of 2 rows 2 columns including the pushed symbol 180, as shown in FIG. 4 (S205). In the mean time, when there are plural rotatable areas 185, it is switched into another rotatable area 185 on condition that an operation signal is again inputted.

After that, it is determined whether the touch panel 69 is dragged (S206). When the touch panel is not dragged (S206, NO), the step of S209 is executed, so that it is determined whether an allowed selection time has lapsed (S209). In the mean time, when the touch panel is dragged (S206, YES), the rotatable area 185 is rotated by 90 in the drag direction, as shown in FIG. 5 (S207). As shown in FIG. 6, the symbols are rearranged at the symbols 180 after rotation (S208).

After that, it is determined whether the allowed selection time has lapsed (S209). When the allowed selection time has not lapsed (S209, NO), the process is re-executed from the step of S203 and a rearrangement resulting from a next rotation is possible. In the mean time, when the allowed selection time has lapsed (S209, YES), the display of the remaining time in the approval notifying unit 172 disappears (S210). Then, this routine is ended and the process returns to the game executing process in FIG. 11.

When the process returns to the game executing process, it is acquired a rearrangement-number of each of the symbols 180 rearranged. Specifically, in FIG. 6, a rearrangement-number of “ORANGE” is “8,” a rearrangement-number of “PLUM” is “6” and a rearrangement-number of “CHERRY” is “4” (S16). Then, it is determined whether the rearrangement-number is a set threshold value or more, with respect to each symbol 180 (S17). When the rearrangement-number is a set threshold value or more (S17, YES), the symbol 180 having the rearrangement-number of the set threshold value or more is set as a scatter symbol 182 (S18). At this time, the scatter symbol 182 is displayed with received in the scatter symbol display unit 171. After that, a payout process is executed (S20).

In the mean time, when the rearrangement-number is not a set threshold value or more (S17, NO), it is determined whether a combination of the symbols 180 stopped on the payline L is a winning combination (S19). When it is not a winning combination (S19, NO), it is neither the scatter symbol 182 nor the winning combination. As a result, this routine is ended without paying out a coin.

In the mean time, when a scatter symbol 182 is established (S18) and/or when a winning combination is established (S19, YES), a payout process of S20 is executed. In other words, when a winning combination is established, it is calculated a payout-number of coins based on it. In addition, when a scatter symbol 182 is established, it is calculated a payout-number of coins corresponding to the scatter symbol 182. Then, it is summed a payout number of coins based on a winning combination and a payout number of coins based on the scatter symbol 182.

When depositing the coins to be paid out, predetermined number of credits is added to a credit-number stored in the RAM 43. Meanwhile, when paying out the coins, a control signal is transmitted to the hopper 66, thereby paying out predetermined number of coins. In the mean time, in the display states shown in FIGS. 1 and 6, it is established a winning combination and a scatter symbol 182 of “ORANGE” (S20).

Next, it is determined whether it is made a bonus trigger as a winning combination. In other words, it is determined whether a combination of “APPLE” is arranged on the payline L (S21). When it is determined that the bonus trigger is made (S21, YES), it is executed a bonus game process (S22). In the mean time, when the bonus trigger is not made (S21, NO), it means a losing. As a result, this routine is ended.

Although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A slot machine comprising:
a display having a payline and arranging plural symbols in a matrix pattern; and
a game controller for rearranging the symbols, setting, among the rearranged symbols, a partial symbol matrix in a rotatable area, rotating the partial symbol matrix in accordance with an operation signal inputted from an exterior to rearrange it and awarding a payout determined by a combination of the symbols rearranged on the payline.

2. The slot machine according to claim 1, wherein the game controller selects the partial symbol matrix, based on an operation signal inputted from the exterior.

3. The slot machine according to claim 1, wherein the game controller sets the partial symbol matrix in the rotatable area when it is made a predetermined unit game-number.

4. The slot machine according to claim 1, further comprising a touch panel provided to a front surface of the display and outputting the operation signal through an exterior input.

5. A slot machine comprising:
A display having a payline and arranging plural symbols in a matrix pattern; and
a game controller for rearranging the symbols, selecting, among the rearranged symbols, a partial symbol matrix, based on an operation signal inputted from an exterior when it is made a predetermined unit game-number, setting the symbol matrix in a rotatable area, rotating the partial symbol matrix in accordance with the operation signal to rearrange it and awarding a payout determined by a combination of the symbols rearranged on the payline.

6. A slot machine comprising:
a display having a payline and arranging plural symbols in a matrix pattern;
a touch panel provided to a front surface of the display and outputting an operation signal through an exterior input; and
a game controller for rearranging the symbols, selecting, among the rearranged symbols, a partial symbol matrix, based on the operation signal, setting the symbol matrix in a rotatable area, rotating the partial symbol matrix in accordance with the operation signal to rearrange it and awarding a payout determined by a combination of the symbols rearranged on the payline.

7. A slot machine comprising:
a display having a display and arranging plural symbols in a matrix pattern;
a touch panel provided to a front surface of the display and outputting an operation signal through an exterior input; and
a game controller for rearranging the symbols, selecting, among the rearranged symbols, a partial symbol matrix, based on the operation signal when it is made a predetermined unit game-number, setting the symbol matrix in a rotatable area, rotating the partial symbol matrix in accordance with the operation signal to rearrange it and awarding a payout determined by a combination of the symbols rearranged on the payline.

8. A playing method of a slot machine comprising:
rearranging symbols;
setting, among the rearranged symbols, a partial symbol matrix in a rotatable area;
rotating the partial symbol matrix in accordance with an operation signal inputted from an exterior to rearrange it; and
awarding a payout determined by a combination of the symbols rearranged on a payline.

9. The playing method according to claim 8, wherein the partial symbol matrix is selected on the basis of an operation signal inputted from the exterior.

10. The playing method according to claim 8, wherein the partial symbol matrix is set in the rotatable area when it is made a predetermined unit game-number.

11. The playing method according to claim 8, wherein the operation signal is a signal outputted from a touch panel provided to a front of the symbols.

12. A playing method of a slot machine comprising:
rearranging symbols;
when it is made a predetermined unit game-number, selecting, among the rearranged symbols, a partial symbol matrix on the basis of an operation signal inputted from an exterior,
setting the symbol matrix in a rotatable area;
rotating the partial symbol matrix in accordance with the operation signal to rearrange it; and
awarding a payout determined by a combination of the symbols rearranged on a payline.

13. A playing method of a slot machine comprising:
receiving an operation signal outputted from a touch panel provided to a front of symbols;
selecting, among symbols rearranged, a partial symbol matrix on the basis of the operation signal;
setting the symbol matrix in a rotatable area;
rotating the partial symbol matrix in accordance with the operation signal to rearrange it; and
awarding a payout determined by a combination of the symbols rearranged on a payline.

14. A playing method of a slot machine comprising:
receiving an operation signal outputted from a touch panel provided to a front of symbols;
rearranging the symbols;
when it is made a predetermined unit game-number, selecting, among the rearranged symbols, a partial symbol matrix on the basis of the operation signal;
setting the symbol matrix in a rotatable area;
rotating the partial symbol matrix in accordance with the operation signal to rearrange it; and
awarding a payout determined by a combination of the symbols rearranged on a payline.
